(19) United States
(12) Patent Application Publication
(10) Pub. No.: US 2004/0012906 A1
(43) Pub. Date: Jan. 22, 2004

(54) Device for marking by stamping by successive percussions

(76) Inventors: Patrice Auray, Thil (FR); Maurice Le Tai Van, Miribel (FR)

Correspondence Address: DOWELL & DOWELL PC, SUITE 309, 1215 JEFFERSON DAVIS HIGHWAY, ARLINGTON, VA, 22202

(21) Appl. No.: 10/391,759

(22) Filed: Mar. 20, 2003

(30) Foreign Application Priority Data
Mar. 22, 2002 (FR) 02 03621

(51) Int. Cl. H01H 47/00

(52) U.S. Cl. 361/139

(57) ABSTRACT

The marking device according to this invention comprises:

a point (6) for percussing an object (2) to be marked,

an electromagnet (7) for propelling the percussion point (6), and

a circuit (9) for electrical supply of the electromagnet (7).

This electrical supply circuit (9) comprises:

a controlled switch (12) connected in series with the electromagnet (7),

means (10, 11) for applying, to the terminals of the electromagnet (7), a voltage (U₇) greater than the nominal voltage of this electromagnet (7), and

a current limiter (13) arranged to maintain the intensity of the current (I₇) in the electromagnet (7) below a predetermined threshold.

### FIELD OF THE INVENTION

The present invention relates to a device for marking by successive percussions.

### BACKGROUND OF THE INVENTION

It is known to make a mark on an object by repeatedly propelling a point against this object. At the same time, a head bearing the point is displaced, following the pattern to be produced. At the end of the operation, the mark is constituted by a successions of hollowed traces of impact, for the most part joining.

The propulsion of the point may be pneumatic, thanks to which two modes of piloting are available at the present time. The first of these two modes may be qualified as discontinuous or “point by point” and consists in stopping the head before each percussion. In the second mode of piloting, during the marking, the rythm of the percussions is fixed by design at a predetermined frequency, whereas the head moves without stopping It follows that, with this second mode of piloting, which may be qualified as continuous, the marking may be notably more rapid than with the first mode, although its quality is lesser.

The marking point may also be propelled with the aid of an electromagnet. In that case, only the mode qualified hereinabove as point by point is available, as the point cannot be oscillated at a sufficiently high frequency for the continuous piloting mode to be translated by a substantial saving of time.

For this to be the case, the time necessary for the electromagnet to propel the point with the energy sufficient for a correct marking, would have to be reduced. This is therefore at least one of the objects that the invention intends to attain.

### SUMMARY OF THE INVENTION

To that end, the invention relates to a device for marking by successive percussions, comprising:

a point for percussing an object to be marked,

an electromagnet for propelling the percussion point, and

a circuit for electrical supply of the electromagnet, this electrical supply circuit comprising a controlled switch connected in series with the electromagnet,

characterized in that the electrical supply circuit comprises means for applying, to the electromagnet, a voltage greater than the nominal voltage of this electromagnet, as well as a current limiter arranged to protect the electromagnet by maintaining the intensity of the current in this electromagnet below a predetermined threshold.

### BRIEF DESCRIPTION OF THE DRAWINGS

The invention will be more readily understood on reading the following description given solely by way of example and made with reference to the accompanying drawings, in which:

FIG. 1 is a view in perspective of a marking device according to the invention and comprising an electromagnet for driving a point for percussing an object to be marked.

FIG. 2 schematically shows an electrical circuit that the marking device of FIG. 1 comprises; and

FIG. 3 is a graph representing the intensity of the current in the electromagnet as a function of time.

### DESCRIPTION OF PREFERRED EMBODIMENT

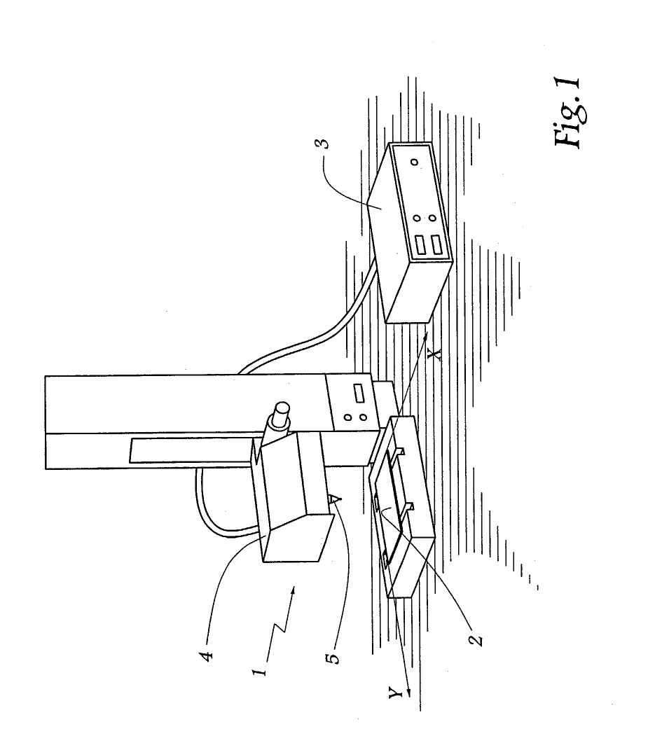

Referring now to the drawings, the marking device shown in FIG. 1 comprises a machine 1 for marking objects such as a metal plate 2, as well as a unit 3 for piloting the machine 1. A box 4 of the machine 1 contains means for displacing a mobile marking head 5 that the machine 1 bears, in directions X and Y.

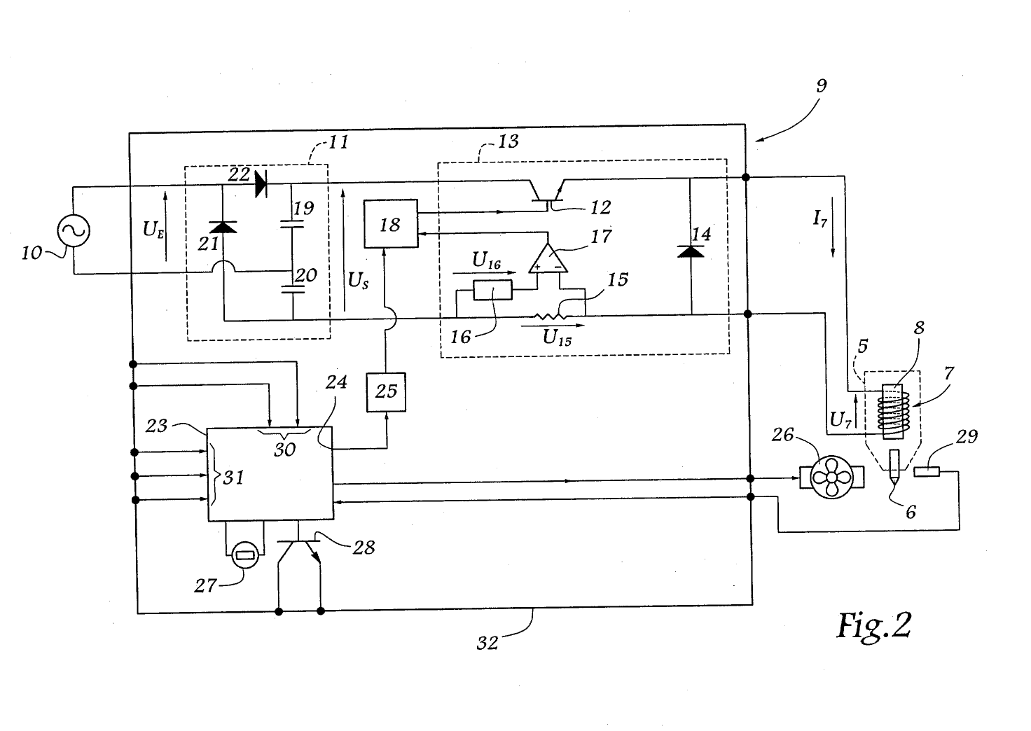

This head 5, which is shown very schematically in FIG. 2, is known per se and comprises a mobile point 6 intended to percuss the plate 2 in order to leave thereon hollowed traces of impact, as well as an electromagnet 7, masked in FIG. 1. The core 8 of this electromagnet 7 is mobile and intended to be launched against the element defining the point 6 in order to propel the latter in the direction of the plate 2.

The electromagnet 7 is electrically supplied by the circuit 9 which is represented in FIG. 2. This circuit 9, according to the invention, comprises a source 10 of A.C. voltage U_{E} and a voltage booster formed by a Latour doubler 11 of which the input is connected to the terminals of the voltage source 10, the output of this doubler 11 being connected in a principal loop where the electromagnet 7 and a controlled switch, formed by a transistor 12, in particular, succeed one another in series.

The voltage source 10 and the voltage doubler 11 are chosen so that the voltage Uₛ at the output of the doubler 11 is substantially greater than the nominal voltage of the electromagnet 7. This output voltage Uₛ may for example be of the order of several times the nominal voltage of the electromagnet 7.

Nominal voltage of the electromagnet 7 is understood to mean the maximum voltage that may be applied indefinitely to the electromagnet 7 without deteriorating it. In practice, this nominal voltage is a design datum of the electromagnet. It may also be determined by means of a sufficiently long test.

The transistor 12 forms part of a current limiter 13 which is provided to limit the intensity of the current 17 in the electromagnet 7. This current limiter 13 further comprises a free wheel diode 14, in parallel with the electromagnet 7, as well as a resistor 15, itself mounted in series with this electromagnet 7, in the principal loop. In addition, means 16 for generating a reference voltage U₁₆, as well as a comparator 17 are provided in the current limiter 13. The means 16 and the comparator 17 are connected so that the latter compares the reference voltage U₁₆ with the voltage U₁₅ at the terminals of the resistor 15. The output of the comparator 17 is indirectly connected to the control electrode, or gate, of the transistor 12. More precisely, it is connected to one of the two inputs of a logic operator 18, of which the output is connected to the control electrode of the transistor 12.

The reference voltage U₁₆ is chosen so as to be equal to the voltage U₁₅ measured at the terminals of the resistor 15 when the latter is traversed by a current having the maximum intensity Iₘₐₓ that the current limiter 13 allows not to be exceeded in the principal loop. If the current I₇ in the electromagnet 7 is less than Iₘₐₓ, the voltage U₁₅ at the terminals of the resistor 15 is less than the reference voltage U₁₆ and the comparator 17 issues the order to maintain the transistor 12 closed. In the contrary case, it issues the order to maintain this transistor 12 open.

The resistor 15 (measurement shunt) being there only to make it possible to measure the intensity of the current I₇ in the electromagnet 7, it is preferable that its presence disturbs the overall functioning of the circuit only slightly. In particular, its value is chosen so that the voltage U₁₅ at its terminals is negligible or low with respect to the voltage Us at the output of the doubler 11.

The Latour doubler 11 comprises, in known manner, two capacitors 19 and 20, as well as two rectifier diodes 21 and 22. The voltage source 10 supplies two distinct branches in parallel. A first branch is constituted by the placing in series of the diode 21 and of the capacitor 20, and the second branch is constituted by the diode 22 and the capacitor 19 in series, a terminal of the capacitor 19 being connected to a terminal of the capacitor 20. The output voltage Uₛ of the doubler 11 is collected at the terminals of the circuit formed by the two capacitors 19 and 20. It supplies the principal loop, comprising the transistor 12 and the electromagnet 7. Functioning of the Latour doubler 11 is known per se.

A micro-controller 23 is provided to control the functioning of the electromagnet 7. To that end, one of its outputs, referenced 24, is connected to the other input of the logic operator 18, via a timer 25. This logic operator 18 is of the “AND” type, i.e. adapted to verify the combination of two conditions. More precisely, it executes the order to maintain the transistor 12 closed only if it receives this order both from the comparator 17 and from the timer 25.

The micro-controller 23 is also provided to control a fan 26, an electroluminescent diode 27 and a transistor 28, from a signal emitted by a thermistor 29 forming means for measuring the temperature in the immediate vicinity of the point 6. More precisely, as soon as this temperature has exceeded a first predetermined threshold, it puts the fan 26 into service, which sends air onto the point 6 in order to cool it. It switches this fan 26 off once the temperature measured by the thermistor 29 has passed below a second predetermined threshold, lower than the first threshold. If this temperature exceeds a third threshold beyond which the point 6 risks deteriorating rapidly, the micro-controller 23 switches on the electroluminescent diode 27 and closes a transistor 28 in order to indicate the presence of a fault.

The micro-controller 23 comprises inputs 30 for its programmation and three inputs 31 for instructions coming from the piloting unit 3.

With the exception of the voltage source 10, the elements constituting the electrical supply circuit 9, including the logic operator 18, the timer 25 and the micro-controller 23, are implanted on a card 32 which is installed in the box 4, i.e. in the vicinity of the head 5.

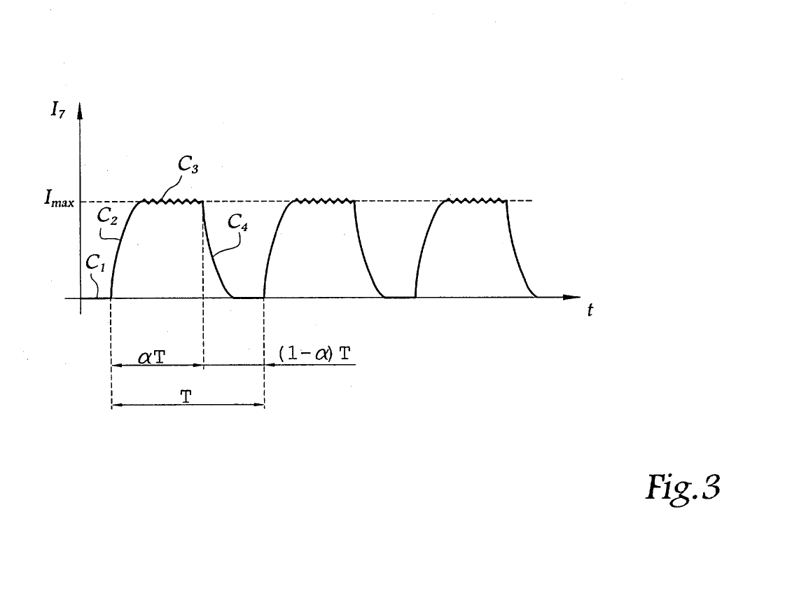

The functioning of the electrical circuit 9 shown in FIG. 2 will now be described, disregarding the effect of the resistor 15 in the afore-mentioned principal loop and also referring to FIG. 3 which illustrates the development, during time t, of the current I₇ circulating in the electromagnet 7.

When the micro-controller 23 sends the order to maintain the transistor 12 open, this order is systematically transmitted by the timer 25, then by the logic operator 18, so that it arrives at this transistor 12. This occurs in portion C₁ of the graph of FIG. 3. The capacitors 19 and 20 are charged until the voltage Uₛ at their terminals is equal to double the amplitude of the A.C. voltage U_{E}. The current in the principal loop being nil, the comparator 17 emits the order to maintain the transistor 12 closed, this order not being transmitted by the logic operator 18 for the moment.

When the micro-controller 23 then gives the order to close the transistor 12, the timer 25 triggers off and transmits this order to the logic operator 18. As this operator 18 receives the order to close the transistor 12 both from the timer 25 and from the comparator 17, it closes this transistor 12. The voltage Uₛ is applied to the terminals of the electromagnet 7, in which the capacitors 19 and 20 are discharged. This occurs in portion C₂ of the curve shown in FIG. 3.

As the voltage Uₛ is clearly greater than the nominal voltage of the electromagnet 7, the power furnished to this electromagnet 7 and therefore the acceleration of the mobile core 8 are clearly greater than what they would be if the voltage applied to the terminals of this electromagnet 7 were of the order of its nominal voltage. It follows that, in accordance with the object of the invention, the time necessary for propelling the point 6 is short, and in particular reduced with respect to that obtained by using the device among those of the prior art mentioned in the preamble which comprises an electromagnet.

Consequently, it becomes interesting to pilot the marking in accordance with the mode qualified hereinabove as continuous, which means in particular that the micro-controller 23 emits a periodic signal destined for the transistor 12. Over a period T, this signal successively comprises an order to maintain the transistor closed and an order to maintain it open. In FIG. 3, the duration of the order to maintain the transistor 12 closed and that of the contrary order are respectively denoted αT and (1−αT).

As long as one is on part C₂ of the curve shown in FIG. 3, the current I₇ increases rapidly until it attains the maximum intensity Iₘₐₓ. From that instant, and as long as the logic operator 18 receives from the timer 25 the order to maintain the transistor 12 closed, the current limiter 13 limits the intensity of the current I₇ to this maximum value Iₘₐₓ (portion C₃ of the curve shown in FIG. 3) and thus protects the electromagnet 7 against an overintensity which would deteriorate it.

As soon as the logic operator 18 receives from the micro-controller 23, via the timer 25, the order to open the transistor 12, the latter is then immediately opened and the electromagnet 7 is demagnetised, generating a current I₇ which passes in the free wheel diode 14 and decreases rapidly, this corresponding to the portion C₄ of the curve shown in FIG. 3.

The period T is chosen to have the desired percussion frequency. It is advantageously included between 8 ms (milliseconds) and 100 ms, and preferably between 12 ms and 40 ms. The cyclic ratio α determines the duration during which the mobile core 8 is accelerated and therefore makes it possible to adjust the energy with which the point 6 percusses the plate 2 to be marked.

The marking may, of course, equally well be piloted in point by point mode. In that case, the micro-controller 23 begins to emit the order to maintain the transistor 12 closed only after the head 5 has stopped.

The timer 25 acts as a safety device in the event of failure of the micro-controller 23, by no longer transmitting an order to maintain the transistor 12 closed beyond a predetermined duration.

Apart from forming part of the voltage doubler 11, the capacitors 19 and 20 are also provided to store a sufficient quantity of energy in order to be able to release the desired power, during the desired duration, after the micro-controller 23 has emitted the order to close the transistor 12. It will be noted that the rise in voltage with the aid of the doubler 11 makes it possible to store this quantity of energy by means of capacitors 19 and 20 of lesser capacity, which presents the advantage of allowing the dimensions of the card 32 to be reduced.

Moreover, the use of the voltage doubler 11 makes it possible to use a source 10 delivering a voltage Uₛ which is sufficiently low to present no danger for the user (safety voltage), this being all the more advantageous as this source 10 is located outside the machine 1, for example in the piloting unit 3.

Among the advantages of the invention, it will be noted that it makes it possible to increase the power and therefore the total energy supplied to the mobile core 8 and to the point 6, taking as base for comparison the device among those of the prior art mentioned in the preamble which contains an electromagnet. This is applicable whether the point by point mode is used for piloting the marking or whether the continuous mode is used. This advantage makes it possible, for example, to increase the depth of the hollowed traces of impact.

The invention is not limited to the form of embodiment described hereinbefore. In particular, the transistor 12 performs a dual function with the aid of the logic operator 18. On the one hand, it forms part of the current limiter 13. On the other hand, it forms part of the circuit controlling the supply of the electromagnet 7. Consequently, this transistor 12 and the logic operator 18 may be replaced by two controlled switches such as transistors, these two switches being connected in series with the electromagnet 7, in the principal loop, and controlled, one directly by the timer 25 and the other by the comparator 17.

What is claimed is:

1. Device for marking by successive percussions, comprising:
a point for percussing an object to be marked,
an electromagnet for propelling the percussion point, and
a circuit for electrical supply of the electromagnet, this electrical supply circuit comprising a controlled switch connected in series with the electromagnet,
wherein the electrical supply circuit comprises means for applying, to the electromagnet, a voltage greater than the nominal voltage of this electromagnet, as well as a current limiter arranged to protect the electromagnet by maintaining the intensity of the current in this electromagnet below a predetermined threshold.

2. The device of claim 1, wherein said means for applying a voltage comprises a voltage source and a voltage booster placed between this voltage source and the electromagnet, the voltage booster for increasing voltage comprising two capacitors arranged to store the energy coming from the voltage source and to restore this energy to the electromagnet.

3. The device of claim 2, wherein the voltage booster is a so-called Latour doubler, the voltage source being intended to supply an A.C. voltage, said capacitors being connected in order to discharge via the electromagnet.

4. The device of claim 1, wherein it comprises a logic operator placed in order to control the controlled switch, the current limiter comprising this controlled switch, a free wheel diode, a resistor in series with the electromagnet, means for generating a reference voltage, a comparator placed to compare the voltage at the terminals of the resistor with the reference voltage and to deliver to the logic operator a first order to maintain the controlled switch closed when the voltage at the terminals of the resistor is less than the reference voltage, the logic operator being provided to close the controlled switch only if it receives both this first order and a second order to maintain the controlled switch closed, the free wheel diode being placed in a loop comprising the electromagnet but not the controlled switch.

5. The device of claim 1, wherein it comprises means for generating a periodic signal destined for the controlled switch, this signal having a period over which it successively comprises an order to maintain the controlled switch closed and an order to maintain it open, this period being included between 8 ms and 100 ms.

6. The device of claim 5, wherein it comprises a safety timer which is placed downstream of the means for generating the periodic signal and which is provided to stop transmitting, after a predetermined duration, the order to maintain the controlled switch closed.
